(19) United States
(12) Patent Application Publication
(10) Pub. No.: US 2016/0195201 A1
(43) Pub. Date: Jul. 7, 2016

(54) Hose Assembly with Multistage Abrasion Indicator

(71) Applicant: EATON CORPORATION, Cleveland, OH (US)

(72) Inventors: Ian C. McCallister, Holland, OH (US); Charles T. Simmons, Kent, OH (US); Mark E. DuVernay, Bryan, OH (US); Jason D. Stark, Temperance, MI (US)

(73) Assignee: Eaton Corporation, Cleveland, OH (US)

(21) Appl. No.: 14/653,592

(22) PCT Filed: Dec. 17, 2013
(86) PCT No.: PCT/US2013/075713

§ 371 Date: Jun. 18, 2015

Related U.S. Application Data
(60) Provisional application No. 61/739,093, filed on Dec. 19, 2012.

(51) Int. Cl. F16L 11/08

(52) U.S. Cl. CPC F16L 11/08

(57) ABSTRACT

A hose includes an outermost layer and an inner layer disposed within the outermost layer. The outermost layer has a first color. The inner layer defines a passageway that extends longitudinally through the inner layer. A reinforcement layer is disposed between the inner layer and the outermost layer. A hose cover is disposed between the reinforcement layer and the outermost layer. The hose cover has a second color. An overlay layer is disposed between the outermost layer and the hose cover. The overlay layer has a third color that is different than the first color of the outmost layer and the second color of the hose cover.

### RELATED APPLICATIONS

This application is being filed on 17 Dec. 2013, as a PCT International Patent Application and claims priority to U.S. Patent Application Ser. No. 61/739,039 filed on 19 Dec. 2012, the disclosure of which is hereby incorporated herein by reference in its entirety.

### BACKGROUND

Abrasion is a frequent reason for hose failure. A disadvantage of prior art hoses is that substantial wear due to abrasion is not immediately obvious upon a cursory visual inspection of the hose.

### SUMMARY

An aspect of the present disclosure relates to a hose. The hose includes an outermost layer and an inner layer disposed within the outermost layer. The outermost layer has a first color. The inner layer defines a passageway that extends longitudinally through the inner layer. A reinforcement layer is disposed between the inner layer and the outermost layer. A hose cover is disposed between the reinforcement layer and the outermost layer. The hose cover has a second color. An overlay layer is disposed between the outermost layer and the hose cover. The overlay layer has a third color that is different than the first color of the outmost layer and the second color of the hose cover.

Another aspect of the present disclosure relates to a hose assembly. The hose assembly includes a hose having an outermost layer and an inner layer disposed within the outermost layer. The outermost layer has a first color. The inner layer defines a passageway that extends longitudinally through the inner layer. A reinforcement layer is disposed between the inner layer and the outermost layer. A hose cover is disposed between the reinforcement layer and the outermost layer. The hose cover has a second color. An overlay layer is disposed between the outermost layer and the hose cover. The overlay layer has a third color that is different than the first color of the outmost layer and the second color of the hose cover. A separation layer is disposed between the overlay layer and the hose cover. The separation layer does not bond to the hose cover.

Another aspect of the present disclosure relates to a method of assembling a hose assembly. The method includes removing an outermost layer and an overlay layer at an end portion of a hose to expose a hose cover at the end portion of the hose. An end portion of a nipple of a fitting assembly is inserted into a passageway defined by an inner layer of the hose. The end portion of the hose is inserted into an end portion of a socket of the fitting assembly. The socket is crimped around the hose cover so that the socket engages the hose cover of the hose.

### DRAWINGS

FIG. 1 is a view of a hose assembly having exemplary features of aspects in accordance with the principles of the present disclosure.

FIG. 2 is a view of a hose suitable for use in the hose assembly of FIG. 1.

FIG. 3 is a cross-sectional view of the hose taken on line 3-3 of FIG. 2.

FIG. 4 is an enlarged fragmentary cross-sectional view of the hose of FIG. 3.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

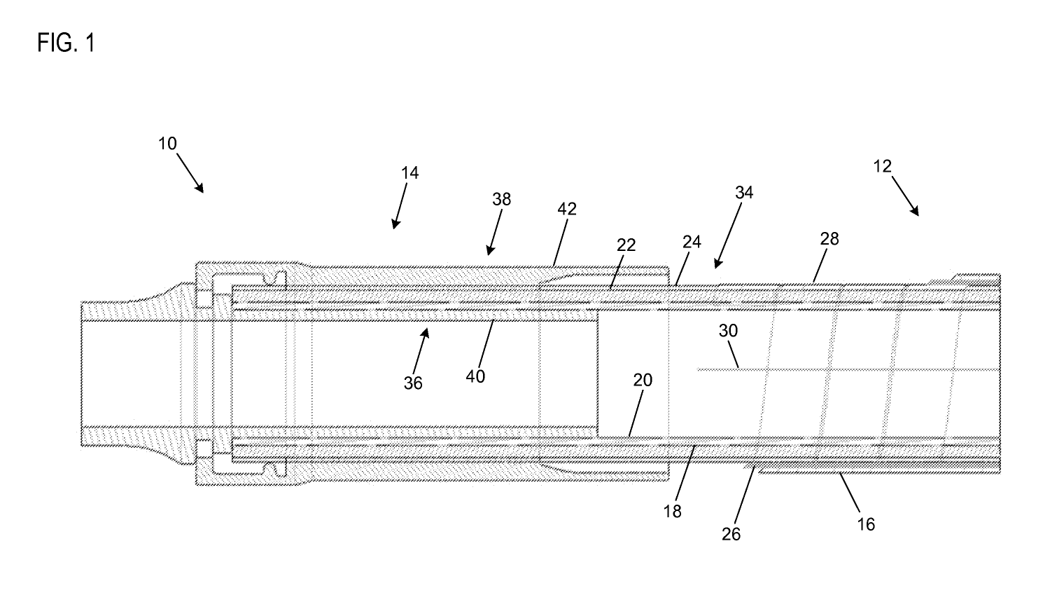

Referring now to FIG. 1, a hose assembly 10 is shown. The hose assembly 10 includes a hose 12 and a fitting assembly 14.

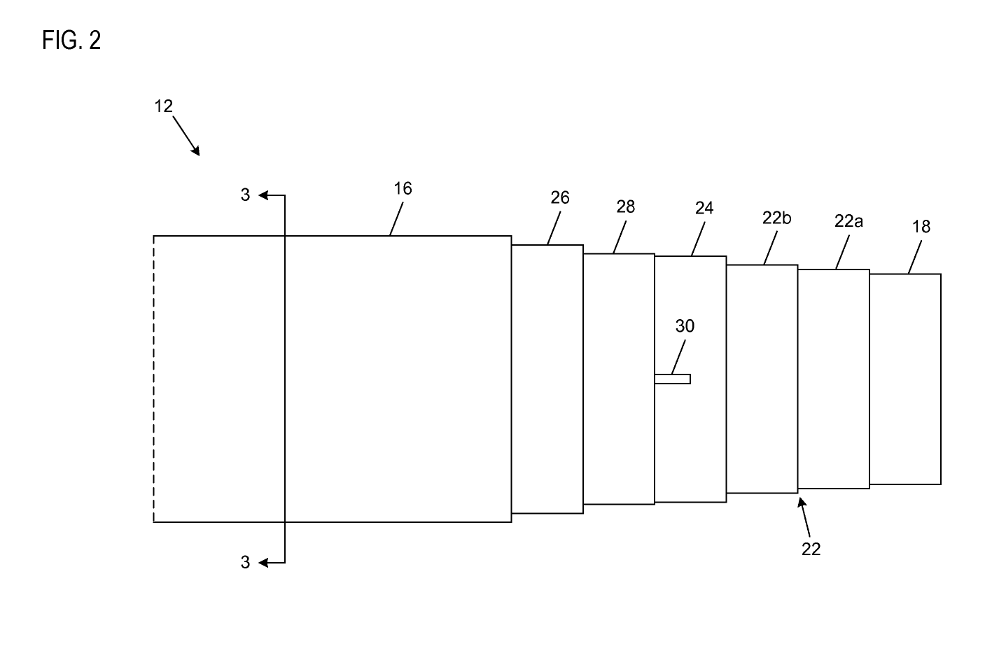

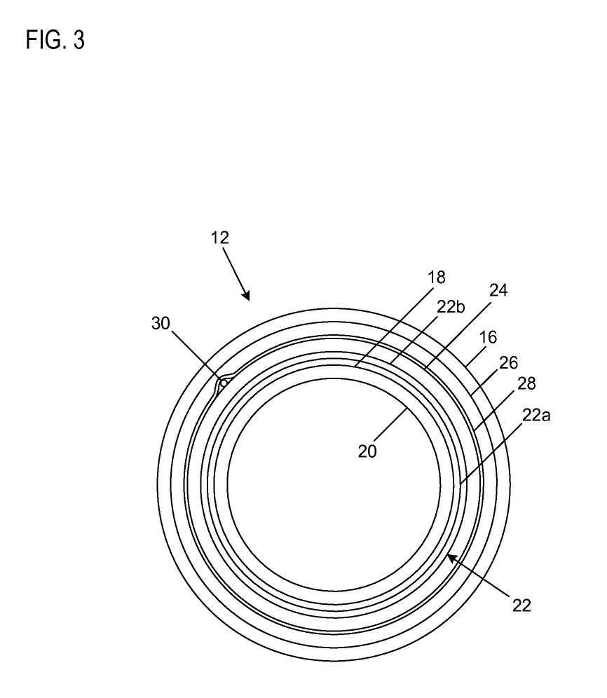

Referring now to FIGS. 1-3, the hose 12 is a multilayer hose. The hose 12 includes an outermost layer 16 and an inner layer 18.

The outermost layer 16 is manufactured from an extrudable material with abrasion resistant properties. In one embodiment, the outer layer 16 is a urethane material. In the depicted embodiment, the outer layer 16 is a polyurethane material. In one embodiment, an exterior surface of the outermost layer 16 has a matte finish.

The outermost layer 16 has a first color. In the depicted embodiment, the first color of the outermost layer 16 is black.

The inner layer 18 is the innermost layer of the hose 12 of the hose assembly 10. The inner layer 18 is disposed within the outermost layer 16 so that the outermost layer 16 surrounds the inner layer 18. The inner layer 18 defines a passageway 20 through which a fluid (i.e., liquid and/or gas) can flow. The inner layer 18 is manufactured from a polyamide material. In the depicted embodiment, the inner layer 18 is manufactured from polyamide 11.

A reinforcement layer 22 is disposed between the outermost layer 16 and the inner layer 18. In the depicted embodiment, the reinforcement layer 22 is disposed immediately adjacent to the inner layer 18 so that the reinforcement layer 22 surrounds the inner layer 18.

In one embodiment, the reinforcement layer 22 is formed by braiding natural fibers, synthetic fibers or metal wires. The synthetic fibers can be glass fibers, polyester fibers, aramid fibers, etc. The metal fibers are usually steel fibers.

In the depicted embodiment, the reinforcement layer 22 includes a first reinforcement layer 22a and a second reinforcement layer 22b. The first reinforcement layer 22a is disposed immediately adjacent the inner layer 18. The second reinforcement layer 22b is disposed between the first reinforcement layer 22a and the outermost layer 16. In the depicted embodiment, the second reinforcement layer 22b is disposed immediately adjacent the first reinforcement layer 22a. In the depicted embodiment, the first and second reinforcement layers 22a, 22b are formed from the same material. In the depicted embodiment, the first and second reinforcement layers 22a, 22b are formed by braiding aramid fibers.

A hose cover 24 is disposed between the reinforcement layer 22 and the outermost layer 16. In the depicted embodiment, the hose cover 24 is immediately adjacent to the reinforcement layer 22. The hose cover 24 is manufactured from an extrudable material with abrasion resistant properties. In one embodiment, the hose cover 24 is a urethane material. In the depicted embodiment, the hose cover 24 is a polyurethane material.

The hose cover 24 has a second color. In one embodiment, the second color of the hose cover 24 is the same as the first color of the outermost layer 16. In the depicted embodiment, the second color of the hose cover 24 is black.

In the depicted embodiment, the hose cover 24 includes a plurality of micropores. The micropores allow any fluid disposed between the inner layer 18 and the hose cover 24 to pass through the hose cover 24. The micropores are made in the hose cover 24 by pin-pricking the hose cover 24 in accordance with the American Petroleum Institute (API) Specification 17E.

An overlay layer 26 is disposed between the hose cover 24 and the outermost layer 16. In the depicted embodiment, the overlay layer 26 is immediately adjacent to the outermost layer 16. The overlay layer 26 is manufactured from an extrudable material with abrasion resistant properties. In one embodiment, the overlay layer 26 is a urethane material. In the depicted embodiment, the overlay layer 26 is a polyurethane material.

The overlay layer 26 has a third color. The third color of the overlay layer 26 is different than the first color of the outermost layer 16. In one embodiment, the third color of the overlay layer 26 is a contrasting color to the first color of the outermost layer 16.

In one embodiment, the third color of the overlay layer 26 is different than the first color of the outermost layer 16 and the second color of the hose cover 24. In one embodiment, the third color of the overlay layer 26 is a contrasting color to the first color of the outermost layer 16 and the second color of the hose cover 24.

In one embodiment, the third color has a wavelength of about 480 nm to about 600 nm. In another embodiment, the third color has a wavelength of about 560 nm to about 590 nm. In the depicted embodiment, the third color of the overlay layer 26 is yellow.

In one embodiment, the second color of the hose cover 24 is different than the first color of the outermost layer 16 and the third color of the overlay layer 26, which is different than the first color of the outermost layer 16. In one embodiment, the second color of the hose cover 24 has a wavelength between about 380 nm to about 480 nm. In another embodiment, the second color of the hose cover 24 has a wavelength between about 630 nm to about 780 nm.

Referring now to FIGS. 1-4, the hose 12 further includes a separation layer 28 disposed between the overlay layer 26 and the hose cover 24. In the depicted embodiment, the separation layer 28 is immediately adjacent to the hose cover 24.

The separation layer 28 provides a distinct boundary between the overlay layer 26 and the hose cover 24. The separation layer 28 is a thin layer of material that does not bond with the material of the overlay layer 26 and/or the material of the hose cover 24. The separation layer 28 allows for portions of the overlay layer 26 and the outermost layer 16 to be removed from the hose 12 without damaging the hose cover 24.

In one embodiment, the material of the separation layer 28 is polyester film. In another embodiment, the material of the separation layer 28 is a biaxially-oriented polyethylene terephthalate.

The separation layer 28 is wrapped about the hose cover 24 during manufacturing. In the depicted embodiment, the separation layer 28 is helically wrapped about the hose cover 24.

At least one filament 30 is disposed between the separation layer 28 and the hose cover 24. In the depicted embodiment, the filament 30 extends longitudinally along the hose 12. In the depicted embodiment, the filament 30 is a monofilament.

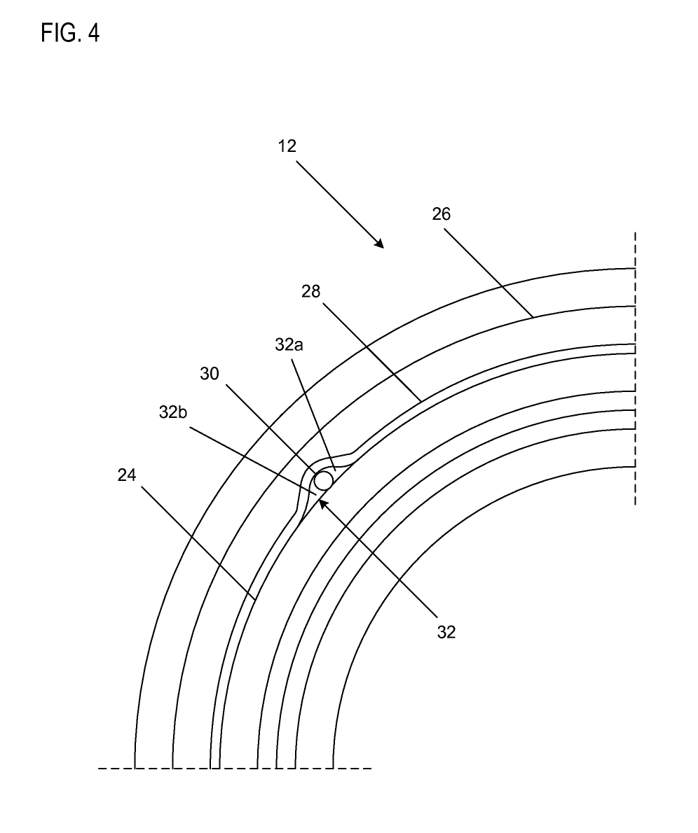

Referring now to FIG. 4, the separation layer 28 and the filament 30 cooperatively define a passage 32. In the depicted embodiment, the separation layer 28 and the filament 30 define a first passage 32a on a first side (e.g., right side) of the filament 30 and a second passage 32b on a second side (e.g., left side) of the filament 30. The passage 32 provides a pathway for fluid (e.g., air, etc.) that passes through the micropores of the hose cover 24 to get to the ends of the hose 12. The passage 32 prevents fluid from collecting under the overlay layer 26 and damaging the structural integrity of the hose 12.

Referring now to FIGS. 1-4, the outermost layer 16, the overlay layer 26 and the hose cover 24 of the hose 12 provide for multistage abrasion wear detection. When abrasion of the outmost layer 16 of the hose 12 results in wear through the outermost layer 16, the third color of the overlay layer 26 becomes visible. In the embodiment in which the third color of the overlay layer 26 is a color with a high contrast from the first color of the outermost layer 16, the third color is clearly visible even in applications with little light including but not limited to subsea applications. When a technician, operator or owner notices that the third color of the overlay layer 26 is visible, the technician, operator or owner can begin to take steps to get a replacement hose.

When abrasion of the overlay layer 26 results in wear through the overlay layer 26, the second color of the hose cover 24 becomes visible. In the embodiment in which the second color of the hose cover 24 is a color with a high contrast from the third color of the overlay layer 26, the second color of the hose cover 24 is clearly visible even in applications with little light including but not limited to subsea applications. When a technician, operator or owner notices that the second color of the hose cover 24 is visible, the technician, operator or owner will replace the hose 12.

This multistage abrasion detection approach provides time for the technician, owner or operator to identify the abrasion issue and take steps to get a replacement hose without needing to cease operation of equipment using the hose 12. Therefore, this multistage abrasion detection approach reduces equipment down time.

Referring now to FIGS. 1-3, a method for assembling the hose assembly 10 will be described. The fitting assembly 14 is disposed at an end portion 34 of the hose 12. In the depicted embodiment, the fitting assembly 14 includes a nipple 36 that engages the inner portion of the hose 12 and a socket 38 that engages an outer portion of the hose 12.

Prior to installing the fitting assembly 14, an incision is made circumferentially around the end portion 34 of the hose 12. The incision cuts through the outermost layer 16 and the overlay layer 26 but does not cut through the hose cover 24. As the overlay layer 26 is not bonded to the hose cover 24 due to the presence of the separation layer 28, the outermost layer 16 and the overlay layer 26 of the end portion 34 can be easily removed from the hose 12. In one embodiment, the separation layer 28 is removed from the end portion 34 of the hose 12. In one embodiment, the filament 30 is cut at the end portion 34 of the hose 12. With the outermost layer 16 and the overlay layer 26 removed from the end portion 34 of the hose 12, the hose cover 24 is exposed at the end portion 34.

The nipple 36 includes an elongated cylindrical end portion 40 that is inserted into the passageway 20 of the inner layer 18. The cylindrical end portion 40 engages the inner layer 18 of the end portion 34 of the hose 12. With the outermost layer 16 and the overlay layer 26 removed, a portion of the end portion 34 of the hose 12 is inserted into a cylindrical shaped end portion 42 of the socket 38. The end portion 42 of the socket 38 engages the hose cover 24 of the end portion 34 of the hose 12.

The nipple 36 and socket 38 can be secured to the end portion 34 of the hose 12 by crimping the socket 38 overlaying the hose cover 24 of the hose 12. The crimping process deforms the socket 38, thereby compressing the end portion 34 of the hose 12 between the nipple 36 and the socket 38. In the one embodiment, the nipple 36 and the socket 38 include serrations that at least partially embed into the hose material when the socket 38 is crimped.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A hose comprising:
an outermost layer having a first color;
an inner layer disposed within the outermost layer, wherein the inner layer defines a passageway that extends longitudinally through the inner layer;
a reinforcement layer disposed between the inner layer and the outermost layer;
a hose cover disposed between the reinforcement layer and the outermost layer, wherein the hose cover has a second color; and
an overlay layer disposed between the outermost layer and the hose cover, the overlay layer having a third color, the third color being different than the first color of the outermost layer and the second color of the hose cover.

2. The hose of claim 1, wherein the first color of the outermost layer is the same as the second color of the hose cover.

3. The hose of claim 2, wherein the first color and the second color are black.

4. The hose of claim 1, wherein the third color has a wavelength of about 480 nm to about 600 nm.

5. The hose of claim 1, wherein the third color is yellow.

6. A hose assembly comprising:
a hose having:
an outermost layer having a first color;
an inner layer disposed within the outermost layer, wherein the inner layer defines a passageway that extends longitudinally through the inner layer;
a reinforcement layer disposed between the inner layer and the outermost layer;
a hose cover disposed between the reinforcement layer and the outermost layer, wherein the hose cover has a second color;
an overlay layer disposed between the outermost layer and the hose cover, the overlay layer having a third color, the third color being different than the first color of the outermost layer and the second color of the hose cover; and
a separation layer disposed between the overlay layer and the hose cover, wherein the separation layer does not bond to the hose cover.

7. The hose assembly of claim 6, wherein the hose cover includes a plurality of micropores.

8. The hose assembly of claim 6, wherein a material of the hose cover is a polyurethane material.

9. The hose assembly of claim 8, wherein a material of the separation layer is a biaxially-oriented polyethylene terephthalate.

10. The hose assembly of claim 6, wherein the separation layer is helically wrapped about the hose cover.

11. The hose assembly of claim 6, further comprising a fitting assembly engaged to an end portion of the hose.

12. The hose assembly of claim 11, wherein the fitting assembly includes a nipple engaged to an inner surface of the inner layer and a socket engaged to an exterior surface of the end portion of the hose.

13. The hose assembly of claim 12, wherein the socket is engaged to the hose cover.

14. The hose assembly of claim 6, further comprising a filament disposed longitudinally between the separation layer and the hose cover.

15. The hose assembly of claim 14, wherein the filament is a monofilament.

16. The hose assembly of claim 14, wherein the filament and the separation layer cooperatively define a passage.

17. A method of assembling a fitting assembly to a hose, the method comprising:
removing an outermost layer and an overlay layer at an end portion of a hose to expose a hose cover at the end portion of the hose;
inserting an end portion of a nipple of a fitting assembly into a passageway defined by an inner layer of the hose;
inserting the end portion of the hose into an end portion of a socket of the fitting assembly; and
crimping the socket so that the socket engages the hose cover of the hose.

18. The method of claim 17, wherein the outermost layer has a first color, the hose cover has a second color and the overlay layer has a third color that is different than the first and second colors.

19. The method of claim 17, further comprising, removing a separation layer disposed between the hose cover and the overlay layer from the end portion of the hose.

20. The method of claim 19, further comprising, cutting a filament from the end portion of the hose.
